(19) United States
(12) Patent Application Publication
(10) Pub. No.: US 2009/0132949 A1
(43) Pub. Date: May 21, 2009

(54) METHODS AND SYSTEMS FOR TRANSMITTING, RECEIVING AND ANNOTATING INTERNET CONTENT

(76) Inventor: Jason Bosarge, Salt Lake City, UT (US)

Correspondence Address: Workman Nydegger;1000 Eagle Gate Tower, 60 East South Temple, Salt Lake City, UT, 84111, US

(21) Appl. No.: 11/941,312

(22) Filed: Nov. 16, 2007

(51) Int. Cl. G06F 3/048

(52) U.S. Cl. 715/777

(57) ABSTRACT

Interfaces and embodiments are provided for sending a transmission of Web content from one browser application to another browser application with commentary and annotations. The content of the transmission is sent, received and displayed without requiring the use or display of a traditional email interface. The content of a transmission is automatically loaded into a background tab of a browser at a recipient system and is subsequently displayed when the corresponding tab is selected by the recipient.

### BACKGROUND OF THE INVENTION

1. The Field of the Invention

The present invention generally relates to Internet browsing and to improved Internet browsers.

2. The Relevant Technology

Even though the basic techniques for browsing the Internet, or World Wide Web, haven't really changed that much since the first browsers appeared in the early 1990's, the use and application of the Internet has grown significantly since its inception. This can be attributed to the substantial increase in information available over the Internet as well as the improvements in networking and transmission speeds at which information can be accessed.

Without doubt, the Internet has become an indispensable tool in a broad range of persistent activities, including information research, basic communication and even social experimentation and community development.

One current method for accessing content over the Internet occurs when a user enters a URL (domain name) into a browser address bar. This causes the browser to load and display the Web content that is associated with the entered URL. The selection of a displayed hyperlink, such as with a mouse click, can also cause a browser to load and display the Web content associated with the selected hyperlink.

Hyperlinks are typically displayed as highlighted text within the content of a webpage rendered by an Internet browser. However, applications other than traditional Internet browsers have also been modified to display Internet-type hyperlinks. For example, hyperlinks are now recognized and displayed by word processing applications, spreadsheet applications and communication applications such as email.

Selection of a hyperlink within a non-browser type application will typically cause a browser to be loaded that is specifically configured to fetch and display the content that is referenced through the hyperlink. Then, after the browser is loaded, the browser will load the Internet content associated with the selected hyperlink.

The use of hyperlinks within Web content is quite prevalent. The occurrence of hyperlinks being sent through emails has also become increasingly more prevalent as the use of the Internet continues to increase. In fact, one of the most significant email activities currently involves a user sending a hyperlink to a friend via email and then talking about the related content in one or more email exchanges. It is currently estimated that of the tens of billions of emails are sent every day and that at least tens of millions of those emails involve the transmission of a hyperlink and corresponding discussions about the hyperlinked content.

Despite the popularity of sending emails with hyperlinks to Web content, there are some problems that can result. For example, there is a risk that the Internet content that was initially referenced by a hyperlink will be removed, changed or become inaccessible before the recipient of the email has had an opportunity to select the hyperlink and load the corresponding content. Sometimes, it is also difficult to properly copy hyperlinks into an email and in such a way that they will properly launch a Web browser when they are subsequently clicked on.

Although hyperlinks provide one way to exchange Web content through email, they are not the only way. For example, user can directly copy and paste Web content into the body of an email message. Web content can also be attached at as separate file to an email. Attaching Web content directly within a message body or as an attachment can be useful, for example, to help minimize the requirement that the recipient of the email launch an Internet browser prior to accessing and viewing the Internet content. It can also overcome problems associated with faulty hyperlinks. In many instances, however, copied Web content cannot be interpreted and displayed properly by an email application.

It can also be quite difficult for to select a specific portion of Internet content (text, pictures and or video), or an entire page, that a sender intends to copy and paste to an email. One reason for this is that the formatting and coding of Internet content prevents Web content from being captured and pasted in the same format that it is displayed by the browser. Accordingly, many Internet users simply choose to send hyperlinks to Internet content, rather than trying to copy, paste and sometimes reformat the Web content.

In addition to the foregoing difficulties associated with emailing Web content, some additional and derivative consequences have also resulted. In particular, emailing of Web content has made it difficult for Web advertisers to ensure that advertisements will be properly attached to the Web content, which they paid for it to be attached to.

There are two basic types of Internet advertising, namely, impression advertising and click-through or pay-per-click (PPC) advertising. In a PPC campaign, the advertiser only pays for actual click-throughs to a certain pre-determined site, such as when users click on displayed links or banners, rather than paying for each impression the advertisement makes.

If a Web user only sees an advertiser link, but does not click through, this is called an impression. Impression advertising, which is less common than the PPC advertising over the Internet, is based on the desire to create an impression to viewers of Web content. Advertisers utilizing an impression advertising campaign pay a flat fee for the right to create an associated impression for all viewers of the webpage or a variable fee based on the estimated number of impressions that the advertisement is determined to create over time and which will typically be based on the total traffic to the webpage that is displaying the advertisement.

As mentioned above, one of the associated consequences of transmitting Web content through traditional email is that Web advertisers are unable to ensure that their advertisements will ultimately be displayed with certain Web content or that the compensation or fee for the advertisements is appropriate. For example, it should be appreciated that the negotiated economies of impression advertising can be thrown out of balance when Web content is copied, pasted and transmitted to an unknown number of email recipients and in an unknown format. This is true irrespective of whether the copied content actually includes or excludes the impression advertisement, and particularly when considering that the emailed content may be forwarded many times over.

The economies of PPC advertising is also disrupted when considering that other linking functionality for copied advertisements can be disabled or unrecognized by many email applications and settings. When the advertisement fails to be copied properly, or at all, the advertiser is not getting the advertising benefit paid for.

In summary, advertisers are currently unable to ensure that their advertisements will be transmitted with Web content that is transmitted, such as through email, for example. To address this concern, some advertisers have begun to pay for advertisements that are attached to emails. However, these systems still do not ensure that the advertisements will ultimately be displayed with any particular set of content, such as the Web content that they were originally selected to be displayed with.

### BRIEF SUMMARY

Some of the problems experienced in the prior art are addressed by or can be mitigated by one or more of the embodiments of the present invention.

Embodiments of the present invention provide improved methods, systems and computer program products for transmitting, receiving, annotating and browsing Internet content and for transmitting communications associated with the Internet content, including advertisements and user commentary. In some embodiments, Internet content and corresponding communications are transmitted between users without relying on traditional email user interfaces. Some embodiments of the invention also include automatic loading of an Internet webpage at a first browser and in response to the webpage being selected for transmission at a second browser.

According to one preferred embodiment, Internet content is manually selected by a user with a first Internet browser application that is hosted by a first computing system. Content can also be automatically identified and selected by a webcrawler or another tool based on any predetermined search and/or detection criteria. The Internet content that is identified is then transmitted within a data transmission sent from the first computing system to a second computing system, which is remotely located from the first computing system, and which is hosting a second Internet browser application of a same or different type than the first Internet browser. The second computing system, upon receiving the data transmission, automatically loads the Internet content at the second computing system with the second Internet browser application. The activity of sending Web content in this manner is sometimes referred to, herein, as Slinging™, sending a Sling™ or sending a Tabsling™.

The automatically loaded content, which was sent from the first computing system, is then displayed at the second computing system, either automatically or, alternatively and selectively, only in response to a user at the second computing system selecting display of the loaded content, and without requiring a traditional email application to be launched at the second computing system in order to identify or display the Web content.

In embodiments which require a recipient to select or request the display of the transmitted Internet content and/or other data, prior to its display, the selection can include the click of a button or another selectable display object within a browser. In one such embodiment, a selectable browser tab is displayed in the background of the second Internet browser application, which identifies the presence of newly loaded content. Selection of the tab causes the loaded content to be displayed, such as, for example, by moving the tab and corresponding content to the forefront (in front of another displayed browser tab) and within a framed interface specifically associated with the tab and that is distinguished from other tabbed frames of the browser.

In some embodiments, the loaded content is displayed within a browser tab that is contained within the chrome interface of the Internet browser, but on a different level, with a different size, a different transparency and/or a different color, than the traditional browser tabs that are displayed within the Internet browser chrome.

In some embodiments, the framed interface associated with the inventive browser tab also includes a communication bar. The communication bar includes a plurality of different configurations for reflecting different information corresponding to the Web content and for facilitating different functionality. In some embodiments, user commentary and/or advertisements associated with the transmitted Web content will be displayed by the communication bar.

Selection of the advertisements for display in the communication bar can be based on contextual relevance to the Web content being transmitted, for example, or the commentary contained within the communications bar. In other embodiments, advertisements are targeted to the profile(s) of an individual or group receiving or sending Web content and/or commenting about the Web content with the inventive tools and interfaces described herein. Advertisements can also be selected randomly or in a predefined order that does not require contextual relevance or profile targeting. Any combination of the above can also be used.

Prior to sending a page of Web content, the Web content can also be annotated with an annotation tool, and such that the annotations will show up along with the Web content when the Web content is subsequently displayed after it is transmitted.

In some embodiments, third party spectators are also enabled to observe the history of Web content and corresponding commentary that has been transmitted within a specific group or that is transmitted to or from a particular user. The ability of an observer to see what is transmitted, however, is subject to privacy settings controlled by the user or group. Observers can also register to receive transmissions of content (e.g., Tablings™) that satisfy certain conditions, such as corresponding to a particular subject matter, in response to a webpage being updated, in response to a WebCrawler identifying particular web content, and so forth.

The foregoing Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates one embodiment of a computing environment in which certain aspects of the invention can be practiced;

FIG. 2A illustrates an Internet interface or browser window that includes one embodiment of a communication bar interface and certain other aspects of the invention;

FIG. 2B illustrates one alternative embodiment of the communication bar interface shown in FIG. 2A;

FIG. 3A illustrates an Internet interface or browser window that includes one embodiment of a communication bar interface and certain other aspects of the invention;

FIG. 3B illustrates one alternative embodiment of the communication bar interface shown in FIG. 3A;

FIG. 4A illustrates one embodiment of a communication bar interface that can be used to add commentary for Web content and for sending Web content;

FIG. 4B illustrates another embodiment of a communication bar interface that can be used to add commentary for Web content and for sending Web content;

FIG. 5A illustrates another embodiment of a communication bar interface that can be used to add commentary and to annotate Web content;

FIG. 5B illustrates another embodiment of a communication bar interface that can be used to display commentary and to view corresponding Web content;

FIG. 5C illustrates another embodiment of a communication bar interface that can be used to add commentary and to send Web content to one or more recipients;

FIG. 5D illustrates an embodiment of an icon that can be selected to display a listing of received and sent web content transmissions;

FIG. 6 illustrates a flowchart of acts associated with sending a transmission of Web content communications from a sender's computing system;

FIG. 7 illustrates a flowchart of acts associated with sending a transmission of Web content communications from an intermediary server system; and

FIG. 8 illustrates a flowchart of acts associated with receiving a transmission of Web content communications at a recipient's computing system.

### DETAILED DESCRIPTION

The present invention extends to methods, systems and computer program products for transmitting and browsing and transmitting Internet content and for transmitting communications associated with the Internet content, including advertisements, annotations and user commentary. In some embodiments, Internet content and corresponding communications are transmitted between users without relying on traditional email user interfaces. Some embodiments of the invention also include automatic loading of an Internet webpage at a first browser and in response to a sender selecting the Internet webpage at a second browser that is remotely located from the first browser.

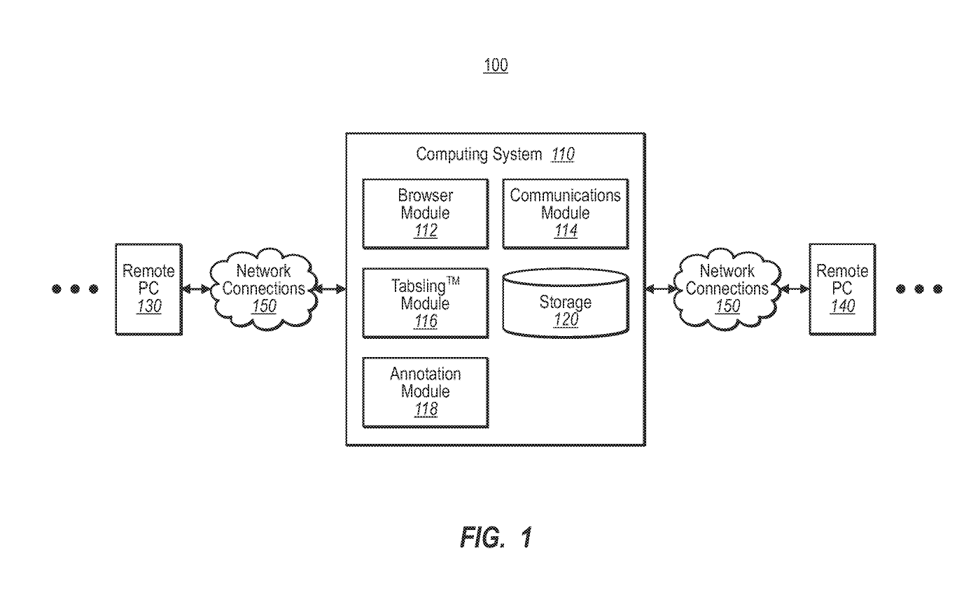

Many of the described and claimed embodiments utilize or comprise a special purpose or general-purpose computer, including various computer hardware and software, as discussed in greater detail below in reference to FIG. 1.

According to one preferred embodiment, Internet content is manually selected by a user with a first Internet browser application that is hosted by a first computing system. That Internet content is then transmitted within a data transmission from the first computing system to a second computing system, which is remotely located from the first computing system, and which is hosting a second Internet browser application of a same or different type than the first Internet browser. The second computing system, upon receiving the data transmission, automatically loads the Internet content at the second computing system with the second Internet browser application within a tabbed window.

To help provide context for many of the terms recited in the claims and throughout the Detailed Description, the definitions for certain terms will now be provided.

The term “Web content” includes any combination of identified content from the Internet. In some instances, Web content includes a single webpage. In other instances, Web content includes a plurality of webpages. Web content can also include any portion of one or more webpages.

The terms “Tabsling™” and “Sling™”, which are used interchangeably herein, are used as both verbs, at times, and as nouns, at times. In the verb context, the terms “Tabsling™” and “Sling™” refer to the described activity of identifying and sending or transmitting content (Web content, commentaries, annotations, and combinations thereof) from one computer to another computer though a Tabsling™ interface or another interface that is configured to cause the content to be automatically loaded at a recipient system. In the noun context, the terms “Tabsling™” and “Sling™” refer to the notification of content having been received at a recipient system, such as through a Tabsling™ interface, as well as the actual content that has been received and that is automatically loaded through the Tabsling™ interface. The Tabsling™ is only one example of a transmission that can be sent according to the methods of the invention. Other transmissions can also be sent and transmitted according to the present invention, irrespective of whether they are called Tabslings™.

The term “Tabsling™ interface” refers to any of the interfaces described herein, including, but not limited to, the communication bar interfaces that are used to identify, annotate, comment about and/or send Web content from one computer to another computer. In many embodiments, the Tabsling™ interface is an interface that identifies and either transmits or displays content that, when it is received at a recipient system, causes the content to be automatically loaded by the recipient system, such as within a background tab of an Internet browser at the recipient system.

The term “tab” refers to the visible object attached to a browser window and that looks like a tab within the chrome of the browser. The tab, as used herein, can also refer to both the tab object as well as the correspondingly attached browser window. A tab can either be displayed in the forefront of a browser, in which case the Web content is visible, or the tab can be displayed in the background, in which case the Web content loaded into that tab is not visible. A tab in the background is moved to the foreground and becomes visible when the tab object or any part of the tab is selected. The present invention refers to two types of tabs, traditional tabs, which are displayed in a first level or portion of the browser chrome and a second set of tabs (Tabsling™ tabs) that function similarly to traditional tabs in some regards, but that are distinguished from traditional tabs insomuch as they are used to display Tabsling™ content which, according to some embodiments, can be any transmitted communication that is transmitted according to the inventive embodiments described herein. The Tabsling™ tabs are also displayed, in some embodiments, in a different layer or portion of the browser chrome than traditional tabs.

The term “chrome” or “browser chrome” refers to the window frame or structure of a displayed browser. Although the browser chrome is often colored, the chrome does not have to be colored. The chrome includes the border around a window used to display Web content. Browser menu options and tabs are traditionally displayed within certain predefined layers or portions of the browser chrome.

As mentioned above, embodiments within the scope of the present invention may include various computer hardware and software. Software is sometimes referred to herein as computer-executable instructions which are contained in one or more computer-readable media.

Such computer-readable media can include storage media and transmission media, as long as they can be accessed by a general purpose or special purpose computer. By way of example, and not limitation, computer-readable storage media can comprise RAM, ROM, EEPROM, CD-ROM or other optical disk storage, magnetic disk storage or other magnetic storage devices, or any other storage medium which can be used to carry and store desired program code means in the form of stored computer-executable instructions or data structures and which can be accessed by a general purpose or special purpose computer.

Transmission media includes wireless network connections over which the computer-executable instructions can be transmitted. Accordingly, when information is transferred or provided over a wireless network or communications connection, that connection is viewed as a computer-readable transmission medium.

The computer-executable instructions stored or carried by the computer-readable media comprise modules or instructions and data which cause a general purpose computer, special purpose computer, or special purpose processing device to perform a certain function or group of functions, such as those described within this application.

### Computing Environment

Attention is first directed to FIG. 1, which illustrates one embodiment of a computing environment 100 that can be used for practicing certain aspects of the invention. As shown, a computing system 110 having various computing modules (112, 114, 116 and 118) and storage 120 is connected through network connection(s) 150, such as the Internet, to one or more remote computing systems 130 and 140.

While the modules (112, 114, 116 and 118) and storage 120 of computing system 110 are shown as discrete and contained elements, it will be appreciated that each of the illustrated modules (112, 114, 116 and 118) and storage 120 can include any combination and number of disparate and/or connected computing elements that are local to the computing system 110 and/or remotely located from the computing system 110. For example, storage 120 is shown as a single storage database contained locally within the structure of computing system 110. However, storage 120 can actually include a plurality of disparate databases and memory, any combination of which are located remotely from the computing system, but which are accessible to the computing system 110 through communications module 114. The same is true of the various modules (112, 114, 116 and 118), each of which can be stored by storage 120.

The functionality of modules (112, 114, 116 and 118) will now be described in more detail. The Browser Module 112, for example, includes sufficient computer-executable instructions for launching and operating a Web browser that is capable of identifying and displaying Web content. Preferably, the Web browser is also capable of utilizing existing Internet searching and browser tools.

In some instances, the Browser Module 112 includes an existing Internet browser, such as Firefox or Explorer. The Browser Module 112 can also be configured to include other Internet browsers and browsing technologies that have not yet been developed. In some instances, the Browser Module 112 includes the executable-code segments that are patches, upgrades, applets or other scripts for modifying an existing browser to implement the methods of the invention, such as for, but not limited to, displaying control options, interfaces and tabs, and including, but not limited to Tabsling™ user interface elements.

The Communications Module 114 includes means for enabling communications between the various illustrated modules (112, 114, 116 and 118) of the computing system 110 as well as other un-illustrated modules of the computing system 110. The Communications Module 116 also includes means for enabling communications between the various modules of the computing system with storage 120 and between the computing system 110 and the various remote computing systems 130 and 140. The means for enabling communications includes computing hardware and software.

The Communications Module 114 also includes computer-executable instructions for notifying a recipient at the computing system 110 of new incoming data transmissions, including one or more Tabsling™ data transmissions, through a browser or another application and irrespective of whether a browser instance is already instantiated. In some embodiments, the Communications Module 114 is configured to pull data from a server, such as from remote computing system 130 or 140, and rather than waiting for data to be pushed to the recipient.

The Communications Module 114 also includes interfaces and computer-executable instructions for tracking and detecting the presence of one or more recipients to whom Web content is addressed and such that the recipients can be properly addressed. For example, the presence of a recipient on a phone or particular computing device can be detected and used to ensure that the data transmissions will be addressed and routed to the recipient at the phone or particular computing device where the recipient is currently detected as being present. Alternatively, an intermediary server, such as one of the remote computing systems 130 or 140 can detect the presence information and route or reroute a data transmission appropriately. The communications module 114 also includes appropriate computer-executable instructions for sending data transmissions, including Tabslings™ and other communications over any desired protocol, including both wired protocols and wireless protocols.

The Tabsling™ Module includes various means for enabling a user to send Web content from a first computer to a second computer without relying on a displayed email interface. The means for enabling the user to send Web content includes computer-executable instructions for identifying Web content with a first browser hosted by the first computer and for transmitting a data transmission to the second computer, without requiring the Web content or a hyperlink to the Web content to be included in a message body of an email message, and which, when received by the second computer, causes a browser at the second computer to automatically load the Web content (for either automatic display or alternatively for display only upon being selected).

The Tabsling™ Module 116 also includes computer-executable instructions for loading Web content identified in a data transmission when a browser is running, as well as at times when a browser is not already running. This may include instructions for automatically loading a browser in a computing background or accessing and loading the identified content without launching a browser interface and such that it is performed transparently to a user.

The Tabsling™ Module 116 also includes computer-executable instructions for managing and controlling user settings with regard to privacy, tracking, loading prioritizations, advertising, and other options for sending, observing and receiving Web content.

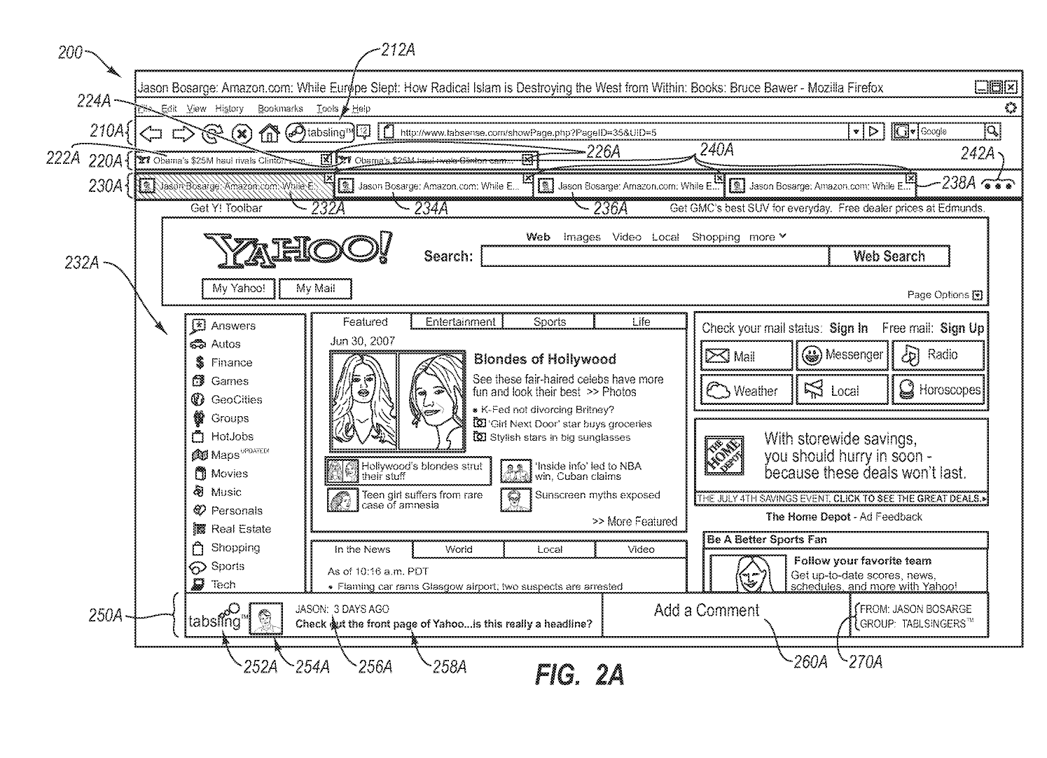

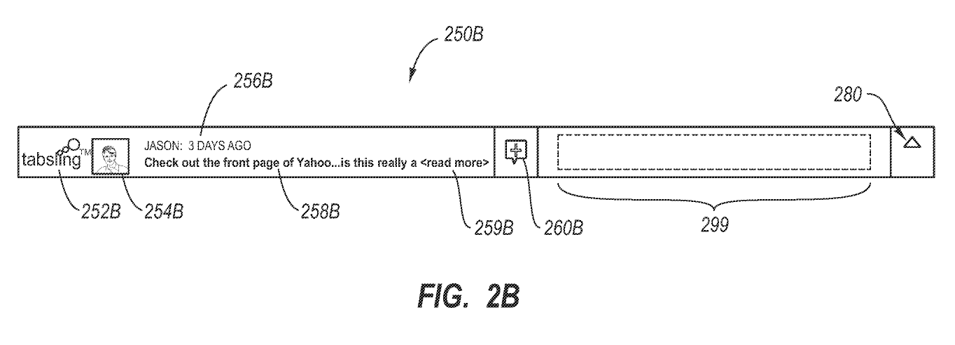

The Tabsling™ Module 116 and/or the Communications Module 114 also include computer-executable instructions for displaying the various interfaces described below, such as the communication bars shown in FIGS. 2A, 2B, 3A, 3B, 4A and 4B and for enabling the communications and other functionality described in reference to those communication bars.

The last illustrated module, the Annotation Module 118, includes computer-executable instructions for enabling Web content to be annotated prior to or after sending the Web content. The Annotation Module 118 can preserve the annotations as part of the Web content, by modifying the actual Web content, or separately from the Web content and can track author information and other historical information associated with the annotations and such that the annotations will subsequently be displayed with the Web content, such as, for example, highlighting or underlining information. In tracking the annotations, the Annotation Module 118 is enabled to track changes made to the Web content by third party sources, such as updates to the Web content. The Annotation Module 118 also includes instructions for tracking and preserving various states of the Web content, before and after annotations and changes have been made to the Web content.

It will be appreciated that the foregoing modules (112, 114, 116 and 118) also include computer-executable instructions for implementing any of the other functionality and processes described below with regard to generating, transmitting, annotating, tracking, viewing, advertising or otherwise processing Web content according to the embodiments of the invention.

It should also be appreciated that, although the remote computing systems 130 and 140 are not illustrated with any included modules, each of the remote systems 130 and 140 can be configured with any combination of the foregoing modules (112, 114, 116 and 118) and storage 120 elements that computing system 110 is illustrated to include. Furthermore, it will also be appreciated that each of the network connection(s) 150 can include any combination and number of wired and wireless connections, which may overlap, even though they are only shown as isolated clouds.

### Methods, Systems and Interfaces

Attention will now be directed to FIG. 2A, which illustrates one embodiment of an Internet or browser interface 200, hereinafter simply referred to as a browser. The browser 200 includes various tools and options that are presented in a first portion of the browser chrome 210A. One of these options is a selectable Tabsling™ option 212A which, when selected, presents one or more Tabsling™ interfaces, including the communication bar interface 250A or any of the other communication bar interfaces illustrated in FIGS. 2B-5.

In some instances, the communication bar interfaces are presented automatically within the chrome of an Internet browser, and without requiring selection of the Tabsling™ option 212A, but rather in response to the browser receiving an inventive data transmission, or in response to another action.

The browser 200 also includes a second portion of browser chrome 220A, where one or more loaded webpages are reflected as tabs 222A and 224A, for example. Each of these tabs 222A and 224A can include options 226A for selecting, restoring, minimizing, moving and/or closing the tabbed Web content. Tabs, such as tabs 222A and 224A, which are shown in the browser chrome portion 220A, are common and known to those of skill in the art.

The present invention also provides for new tabs that are not common or a, obvious to those of skill in the art. One example of the new tabs includes tabs 232A, 234A, 236A and 238A, which are shown in a new browser chrome portion 230A, and which are offset from the chrome portion 220A containing the old tabs 222A and 224A. While the new tabs 232A, 234A, 236A and 238A may appear like the old tabs 222A and 224A, inasmuch as they can also include similar control options 240A for selecting, minimizing, moving or closing the tabs and corresponding content, these new tabs 232A, 234A, 236A and 238A are unlike any existing tabs insomuch as they display Web content that is received or loaded in response to receiving one or more Web content data transmissions.

According to one embodiment, the chrome portion displaying the new tabs is also only created after receiving a Web content data transmission, for example, at a later time than the chrome portion is created for displaying the old tabs.

Although four tabs are shown, any number of tabs (fewer or more) may be presented, as reflected by ellipses 242A. Settings can also be set by a user to control the number of tabs that are loaded at any one time, and so as to prevent too many tabs from being loaded at one time, which could drain or exceed processing resources and bandwidth. As later described, preferences can also be set to control the order in which tabs are loaded when Web content data transmissions are received from one or more sources.

The new browser chrome portion 230A, and corresponding tabs are also preferably, although not necessarily, set apart from the first tabbed portion of the browser chrome 220A. In some embodiments, for example, and as shown, the new tabbed portion 230A is vertically offset from the old tabbed portion 220A. The new tabs can also be set apart on the browser chrome by distinguishing the color of the new tabbed portion of the browser chrome 230A from the old tabbed portion of the browser chrome 220A.

In the present embodiment, a webpage 232 having Web content is displayed within the frame of one of the selected new tabs, 232A for example, in response to a user selecting the new tab 232A. This webpage 232 and the corresponding Web content is also received and initially loaded into the background of the new tabbed chrome portion 230A and in response to a user at a remote computing system sending the page 232A to a user interacting with browser 200.

Notwithstanding the detailed description of the new second layer of tabs that can be created to present Tabslings™ and other data transmissions, it will be appreciated that the invention does not require Tabslings™ and other data transmissions to always be loaded into the new second layer tabs. In fact, other embodiments involve the loading of the data transmissions into folders that are only accessible through menu options. This can occur transparently to the user, without visual notification to the user or, alternatively, this can occur simultaneously with a notification to the user of the transmission. The user can then navigate to the transmitted data through the menu options. In some instances, other frames, besides tabbed browser frames are also used to load the transmitted content.

In some embodiments, a plurality of webpages are identified and included in a single transmission, such as, for example, by utilizing the MRL technologies described in patent application Ser. Nos. 11/320,185 and 60/640,134, which are both incorporated herein by reference. For instance, a user can select a plurality of webpages and then click on the Tabsling™ button 212A, which will identify each of the plurality of webpages for inclusion in a single Web content data transmission.

When more than one webpage is received in a single Web content data transmission or from a plurality of transmissions, each of the webpages is loaded into a different tab on the browser. The ordering of those tabs can be based on priority settings or an order in which they are loaded.

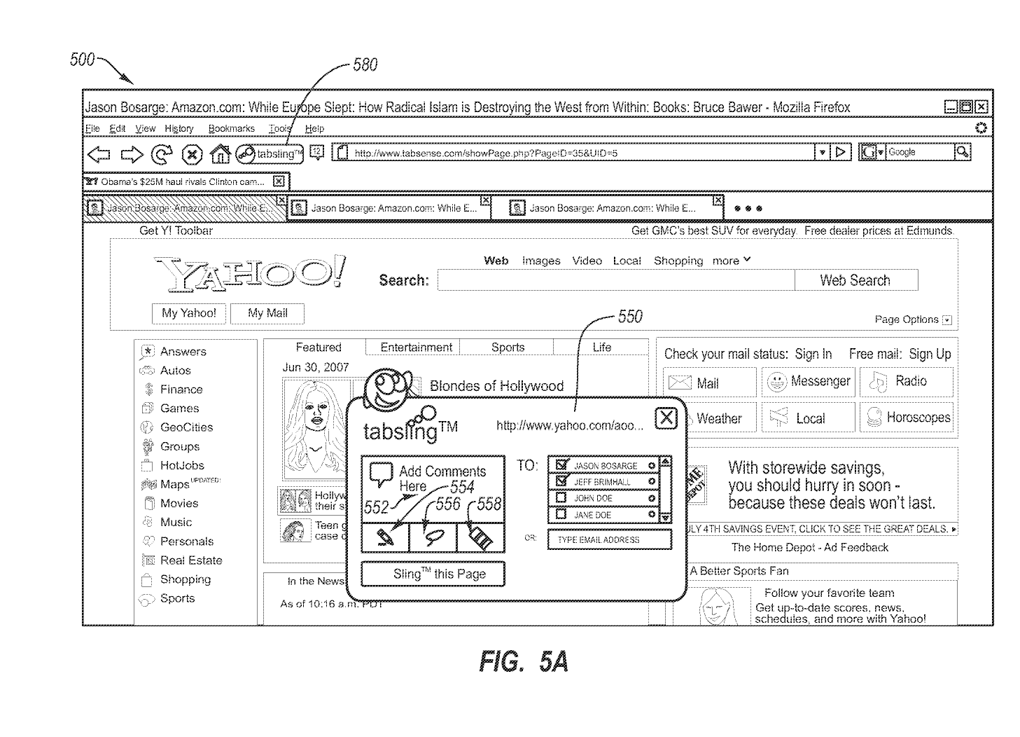

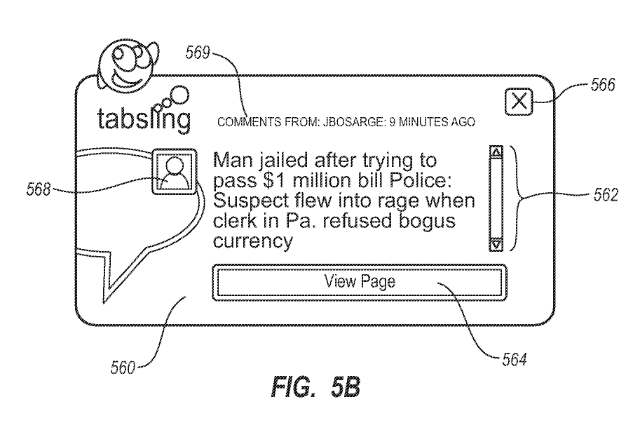

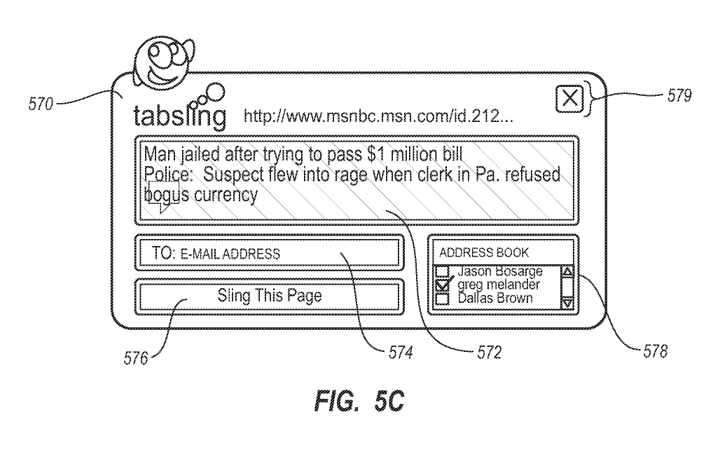

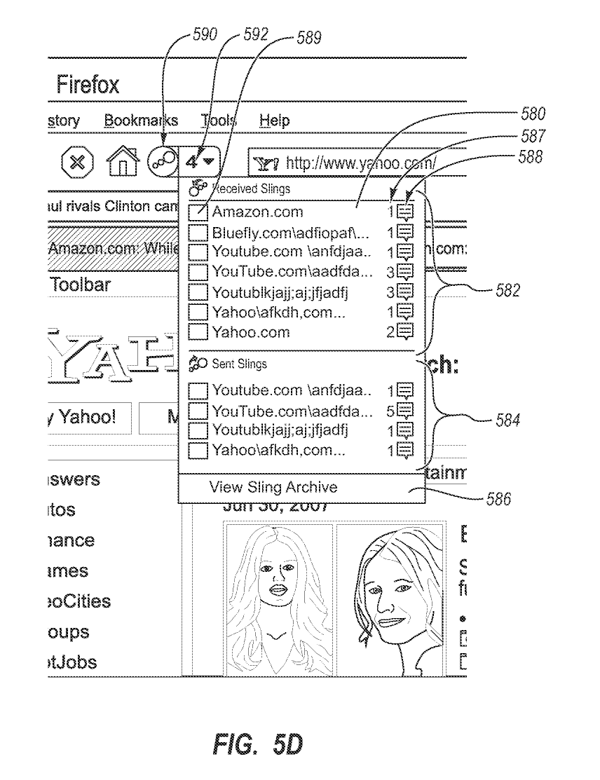

FIG. 2A further illustrates a communication bar 250A at the bottom of the browser 200. This communication bar 250A is also shown to be displayed within the chrome or frame of the browser 200. However, this is not necessarily a requirement, such as illustrated by the embodiment of FIG. 5A.

The communication bar 250A is opened automatically or in response to a user selecting a menu option on the browser, such as, for example, the Tabsling™ option 212A or another menu option. The communication bar 250A can also be preloaded within the frame of each new tab (such as tab 232A, 234A, 236A and 238A), such that whenever one of the new tabs is selected, the communication bar 250A is displayed with the Web content corresponding to the selected tab.

In the present embodiment, the communication bar 250A includes various displays and menu options, such as Tabsling™ display 252A, icon 254A, timing display 256A, commentary interface 258A, commentary button 260A and sender information 270A, each of which will now be described in more detail.

The Tabsling™ display 252A can be a textual and/or graphical advertisement. In some instances, the Tabsling™ display 252A can also be a selectable menu object which, when selected, provides additional menu options or that causes a predefined action to occur, such as the loading of a particular interface.

Icon 254A includes a graphical illustration or picture associated with a particular user or group. In some instances the icon 254A includes a picture or representation of the person who sent the webpage 232A in a Tabsling™, or another data transmission, to the recipient. The icon 254A that is used can be set at the recipient system or, alternatively, provided by the data received in the Tabsling™ or other data transmission.

Timing display 256A reflects an age of the data (how long ago the Web content was sent to the recipient). Alternatively, the timing display 256A can reflect a specific date and/or time in which the content was received. In yet another embodiment, the timing display 256A reflects a data date, corresponding to a date when the Web content being transmitted was posted on the Internet and as defined by metadata associated with the Web content.

Commentary interface 258A includes the portion of the communication bar 250A where textual commentary is displayed. The textual commentary can be provided by the sender and/or any recipient of the data transmission.

In some embodiments, the commentary interface 258A includes a running and real-time record of all commentary received about the data transmission and that is sent to all involved parties. For example, if a Tabsling™ is sent to a group of different recipients, each recipient will receive the commentary. Similarly, if a subsequent commentary is received from one of the group members about the received Tabsling™ and/or another recipient's comments, the new commentary will be sent to all of the members or to at least a sender selected list of the group.

To ensure that received commentaries are displayed with the appropriate dialog and Web content, within the communication bar 250A, the transmission of a commentary from the communication bar 250A will include identifier information that identifies the sender of the communication as well as the intended recipient(s) of the communication and a thread or string identifier that associates the commentary to a particular thread of communications.

One tool for sending communications or commentary through the communication bar 250A includes commentary button 260A. Commentary button 260A is a selectable object which, when selected, opens an interface with input fields for entering text to be transmitted to one or more recipients and options for selecting one or more recipients to send the commentary to.

Sender information 270A includes a name, alias or other identifier associated with the sender of the Web content or a particular commentary that is selected or displayed by the communication bar 250A. Sender information 270A can also include information that identifies a group or listing of individuals that the sender sent the Web content or commentary to.

It will be appreciated, however, notwithstanding the specificity of the foregoing example of FIG. 2A, that there are many other configurations for displaying and utilizing a communication bar with a Tabsling™ interface or another similar interface. By way of example, and not limitation, some additional embodiments of communication bars and interfaces will now be described with reference to FIGS. 2B-5.

The communication bar 250B illustrated in FIG. 2B includes many of the features previously described in reference to FIG. 2A, including a Tabsling™ display 252B, an icon 254B, a timing display 256B, a commentary interface 258B and a commentary button 260B. However, in this instance, commentary button 260B is a more simplified version than the commentary button 260A of FIG. 2A. It will also be noted that the commentary interface 258B includes a ‘read more’ option 259B which can be selected to display additional hidden text for a particular displayed commentary or to display other commentaries in a thread of commentaries from one or more participants.

The FIG. 2B embodiment of the communication bar 250B also includes an option 280 which, when selected, displays other information about a particular Tabsling™ or another data transmission that the communication bar 250B is displayed with. This other information can include information about the sender, the recipient(s) of the data transmission and/or a particular commentary, such as described in reference to the sender information 270A of FIG. 2A. The information that can be displayed can also include information about the Web content that was sent in the data transmission, such as the source or host of the Web content that was included in the transmission or other metadata extracted from the Web content.

In some embodiments, the other information also includes a listing of executables or attachments that were stripped or disabled from the Web content during the transmission process. For example, in some embodiments, the inventive software modules are configured to block certain executables from auto-loading or running from an incoming Web content data transmission. This can be useful, for example, to prevent viruses and undesired pop-ups from being displayed. While this many prevent some advertisements from being displayed, it is not the intent of the present invention to obstruct all advertisements. In fact, to the contrary, many embodiments of the present invention intentionally provide a means for advertising with transmitted Web content and in such a way that an advertiser can be ensured that an advertisement will be displayed with specific content or that is targeted appropriately.

One of the means for advertising includes the dedication of advertising space 299 on the communication bar 250B where advertisements can be displayed and/or linked from. The advertising space 299 will support impression advertising, such as when the entire impression advertisement is displayed within the advertising space, as well as PPC advertising, where hyperlinked text and/or graphics are displayed that link to other advertising content.

The advertisements can be extracted from the Web content being transmitted or, alternatively, can include other advertisements that were not included in the original Web content.

In one embodiment, the displayed advertisements are specifically selected and targeted to a profile of a sender, one or more recipient(s), and/or a particular group. In another embodiment, advertisements are selected according to contextual relevance. More specifically, the advertisements that are selected are the advertisements that are determined to be contextually relevant to content contained in the transmitted webpage and/or to commentary transmitted back and forth through one of the communication bars. The determination of contextual relevance is based on a single word, or a plurality of terms identified within the Web content and/or user commentary. A plurality of different advertisements can also be provided and displayed and linked to in the advertising space, each of which can be contextually related to different sets of one or more terms. The plurality of advertisements can also include one or more advertisements based on contextual relevance and one or more advertisements based on profile data. Various techniques for analyzing content and profiles can be employed, including an analysis of transmitted Web content, membership data, Internet surfing activities, and/or survey data.

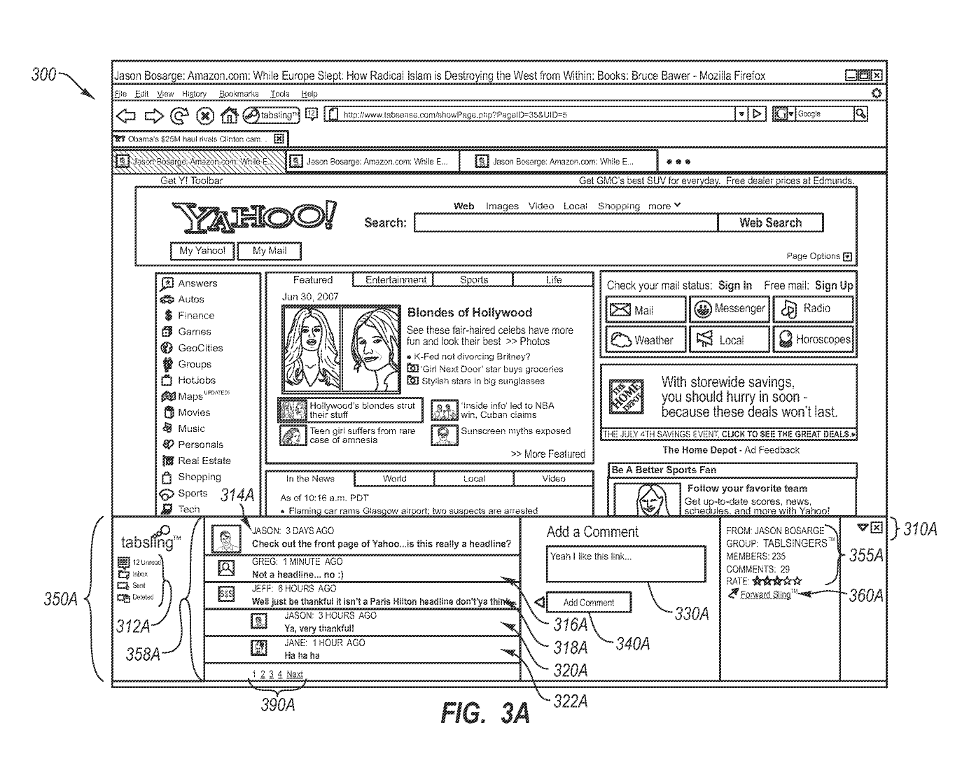

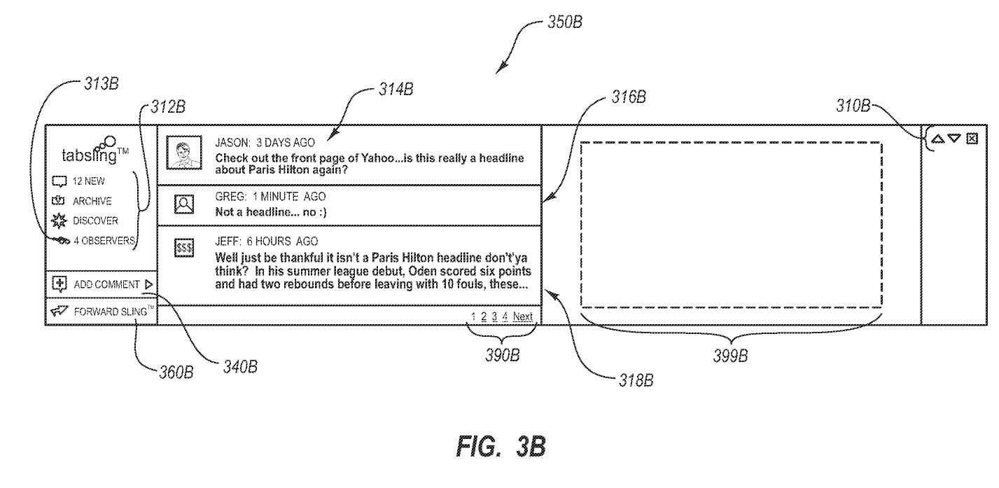

FIG. 3 illustrates another embodiment of the communication bar 350A. In this embodiment, the communication bar 350A is bigger than the previously described embodiments, and can therefore accommodate the display of additional information. This expanded version can be the default version displayed to a user when the user receives and opens a Web content data transmission, such as, but not limited to a Tabsling™. Alternatively, the expanded version can be an alternative or subsequent version that is displayed to a user, such as, for example, in response to a user selecting an expand button or a minimize button. An expand buttons and minimize buttons can be displayed in a corner with other options 310A, for example. In the present embodiment, the other options 310A can also include options for closing or moving the communication bar 350A, as well as options (not shown) for further expanding the communication bar.

In the expanded version, the commentary interface 358A is shown to include a plurality of separate commentaries (314A, 316A, 318A, 320A and 322A), each of which includes an icon, timing information and textual commentaries, and all of which have been previously described.

It will be appreciated that the format for displaying the plurality of commentaries (314A, 316A, 318A, 320A and 322A) within the communication bar 350A can be configured to reflect a particular relationship. For example, the relationship between some of the commentaries can be shown by displaying them with indentations, distinguishing font sizes, colors, or other designations to reflect branches and nodes of a conversation thread. For example, commentary 318A is shown to be indented under commentary 316A, indicating it is a reply or branch to commentary 318A.

The current embodiment of the communication bar 350A also includes a menu 312A having various options for accessing data transmissions, including Tabslings™, commentaries, and other types of data transmissions. Through the menu 312A, for example, a user can search for data transmissions that have been opened and viewed as well as unviewed data transmissions and commentaries. The menu 312A and corresponding options can also be used to identify a particular transmission from a particular sender or a transmission corresponding to a particular subject matter.

As in the previous embodiment, a commentary button 340A is provided for submitting a commentary. Selection of the commentary button 340A can open a text field 330A for entering commentary. Selection of the commentary button 340A can also initiate the transmission of the text that was already typed into text field 330A, such as, for example, when the text field 330A is already opened.

Other options are also provided for communicating through the communication bar 350A. For example, a forward Sling™ option 360A is provided for forwarding the Web content displayed with the communication bar 350A to one or more recipients. Forwarding a Sling™ can also forward all commentaries associated with the Web content. Relationships between commentaries and Web content can be maintained at a remote server and/or the sending and recipient computing systems. Information defining the relationships can also be transmitted to ensure that all related content is properly identified and displayed at the appropriate time.

Finally, it will be noted that communication bar 350A also includes an expanded information section 355A to reflect information about the Sling™, or another transmission, as well as information about the sender of the transmission. In the present embodiment, this information includes a name of the sender, a group of one or more intended recipients, the number of members in that group, commentaries received about the transmitted content and a corresponding rating of the content or Sling™

With regard to the number of commentaries identified, it will be appreciated that it is not necessary for all commentaries to be shown at the same time. Instead, they can be organized into logical groupings, based on space constraints or any other criteria, such as content or member identification. When there are more commentaries available then can be displayed at one time, a scroll bar can be provided for scrolling through the commentaries. Other menu options can also be provided, such as the commentary grouping option 390A, to enable navigation through the commentaries.

The communication bar 350B shown in FIG. 3B is similar to the communication bar 350A shown in FIG. 3A. For example, like communications bar 350A, communication bar 350B also includes options 310B for closing, minimizing or expanding the communication bar 350B, as well as a button 360B for forwarding Web content or commentary in a Sling™, a button 340B for adding a commentary, options 390B for navigating though commentaries, and a display of commentaries 314B, 316B and 318B.

There are a few differences, however. For example, the current menu options 312B include an observer option 313B, which was not included in the embodiment of FIG. 3B. This observer option 313B links to menu interfaces for enabling a user to view the quantity, status and/or profiles of observers. Observers, according to one embodiment, are people who have received a Web content data transmission, such as a Sling™, a commentary, a notice related to a Tabsling™, or a historical listing of transmitted data and who were not designated as intended recipients by the sender of the data transmission(s).

An observer can register to view data transmissions, including Web content and/or commentaries that are sent within a particular group, sent to a particular recipient, sent from a particular sender, corresponding with a particular subject matter, and/or involving a particular webpage. Options for restricting access to observers are provided through the observer option 313B or another menu option.

In some embodiments, an observer may want to view certain content and/or commentaries sent within a group or between particular members, without receiving all content and commentaries that are sent between those particular members or within that particular group. Accordingly, the observer may want to maintain an observer status, rather than register to become a member of any particular group.

A user can also filter the transmissions and commentaries in another way, by registering for a group and by setting filters for the Web content and/or commentaries that are to be received within that group and according to any user defined criteria, such as, for example, based on information that identifies a particular sender, recipient, subject matter and/or that involves a particular webpage. Options for setting such criteria can be presented through any suitable interface (not presently shown), but which can be linked through the menu options 312B or other menu options.

One final difference between the communication bar 350B, of FIG. 3B, and the one (350A) shown in FIG. 3A is the addition of advertising space 399B. This advertising space can support one or more impression and/or PPC advertisements.

Although the advertising space 399B is shown to be attached to the communication bar350B, it will be appreciated that advertising is not limited to the space provided in the communication bar350B. In fact, it is possible to provide advertising that overlays some of the Web content displayed within a Tabsling™ or another display of transmitted Web content and that is detached from the communication bar.

Advertisers who advertise on a webpage being transmitted in existing systems (i.e., traditional email systems) have no assurance that their advertising will be appended to the Web content it was originally selected for. Some embodiments of the present invention, however, can assure that original advertisements will be included with the original Web content. They can do this through agreements established with the Tabsling™ server system and by transmitting entire webpages in the same manner and structure they were originally displayed in.

The present invention also provides means for enhancing advertising by providing techniques for displaying additional advertising in the communication bar, for example, that are targeted to one or more member profile(s) and/or that have been selected to have contextual relevance to the transmitted Web content and/or commentaries.

In some alternative embodiments, newly selected advertisements can also be placed over preexisting advertisements from the Web content. Advertising can also be performed by changing text or other displayed Web content (which was originally unlinked) into a hyperlinked advertisement or text that links to third party content. Advertising according to the present invention can also include changing the destination address of an existing hyperlink in the Web content so that the hyperlink is now redirected to new third party content.

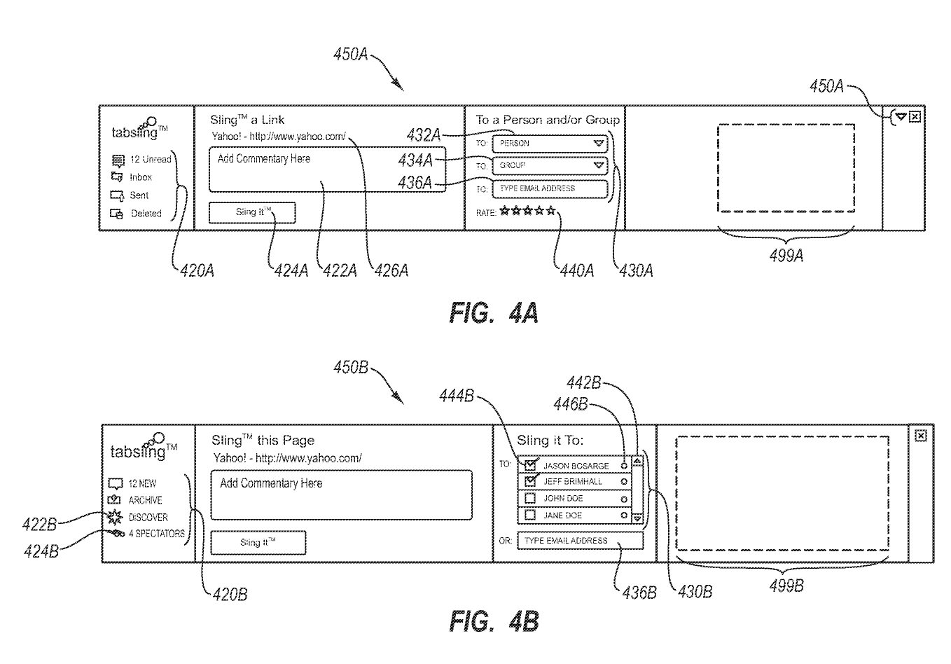

Some additional embodiments of the communication bar 450A and 450B will now be described in reference to FIGS. 4A and 4B. Both of these embodiments are directed to communication bars 450A and 450B that include special options for selecting the recipient(s) of an original or forwarded Sling™. For example, bar 450A includes a first pull-down menu 432A for selecting one or more recipient(s) from a list. This list can include a friends list, for example, which was created by the sender. The list can also be a list that was automatically generated from analyzing one or more contact information directories, including a work directory, an email directory, a phone listing directory or any other directory that includes information that identifies a recipient and that also includes information identifying an address where a data transmission, such as a Tabsling™, can be sent.

Other types of pull-down lists can also be provided that list groups in addition to or instead of individual recipients. Group listings 436A can be useful, for example, to select a plurality of recipients at a single time. The groups can be established through a third party server, by the recipient, the sender or any other party.

Rather than, or in addition to, selecting one or more contact(s) from of the pull-down lists 432A and 434A, an email address field 436A can be provided for receiving the email address of a potential recipient. It will be appreciated, however, that even when an email address is used or when information is sent through an email transmission media, the present invention is still distinguished from existing email systems that require the use of an email interface for copying content or hyperlinks directly into an email message body.

In addition to selecting the recipient(s), the sender can also rate the content being transmitted with a rating interface, such as with the star rating interface 440A. Alternatively, the rating associated with a particular transmission can be automatically set, based on the number of recipients or observers, for example, or the number of comments received for the particular transmission.

In some embodiments, commentary corresponding to a Sling™ or other transmission can be added to a commentary field 442A. The commentary can be sent with or without sending any corresponding Web content. For example, by selecting the ‘sling it’™ link 424A, the typed commentary will be sent to the corresponding recipients that were identified through the pull-down menus 432A and 434A and the email address field 436A.

When Web content has been identified or selected for sending, it can also be identified through the communication bar, such as, for example, within a Web content identifier field 426A. This may include referencing a MRL (multiple resource listing) when multiple webpages are identified for a single transmission.

In some embodiments, the content to be included in a transmission is selected by clicking on a Tabsling™ menu option, such as element 212A in FIG. 2A, when one or more particular webpages are displayed and/or checked for selection. Alternatively, the Web content can be identified by typing the address(es) of the webpages into a URL/MRL field (not shown).

In some embodiments, the sender also has an option to select one or more of the advertisements to be transmitted with the identified Web content and/or commentary. These advertisements can be selected from and/or displayed in the advertising space 499A. Enabling a sender to select advertisements can be used to offset membership costs associated with using the interfaces of the invention or to receive additional benefits, including monetary compensation. In other embodiments, a server or recipient system select the advertisements to be displayed at the recipient system(s) according to established agreements.

The embodiment shown in FIG. 4B is similar to the embodiment shown in FIG. 4A, except that the menu option 430B for selecting the recipient(s) includes a listing of potential recipients that are displayed with check boxes 444B and status identifiers 446A. The check boxes 444B are selected by a sender to indicate that a particular person is an intended recipient. The status identifiers 446B identify an online or offline status of a recipient. This information can be obtained and maintained at a server, by communicating with recipient devices and by accessing stored status information from third party repositories, and which is then pushed to all system users. Alternatively, each system can individually query and ping for this information. A scroll bar 442B is also be provided in the present embodiment to enable a user to scroll through the listing of potential recipients.

Another difference with the bar 450B of FIG. 4B is that the menu options 420B are different than the set of options 420A provided in the bar 450A of FIG. 4A. In particular, there is a new spectator option 424B that was not presented in FIG. 4A, but which was previously described in reference to element 313B of FIG. 3B. A new discover option 422B is also provided. The discover option 422B can be used to identify particular content an observer is interested in. For example, a user can identify, through the discover option 422B, a particular type of content the server should search for. When that content is identified, such as with a WebCrawler, or by examining transmissions that are sent through the server between two or more senders, the identified content is also transmitted to the user. The discover option 422B can also be used to query for and identify a recipient from one or more contact information databases and to add that contact to the displayed listing of recipients, which is described above.

Another embodiment of the communication bar 550 is shown in FIG. 5A. In this embodiment, the communication bar 550 is also configured with a comment field 552 for receiving commentary to be sent. Unlike the previous embodiments, however, a set of edit or annotation options are provided, including options 554, 556 and 558. These options can be used to select and annotate 556, highlight 556, erase 558, or distinguish portions of the Web content that is selected for inclusion in a data transmission or that was received in a data transmission. In the present embodiment, the communication bar 550 is opened when a sender selects the Tabsling™ option 580 from the browser 500.

FIG. 5B illustrates yet another embodiment of a communication bar interface 560 that can be used to displayed, for example, in response to a user selecting the Tabsling™ option 580. However, in this embodiment, the tabslingtm option 580 (or another option, such as icon 590 in FIG. 5D) is selected to open and view a newly received transmission of web content and/or commentary. The user can also be notified that a new transmission is received by coloring, flashing, animating or by otherwise highlighting or changing the Tabsling™ option 580 or another related display object, such as Tabsling™ icon 590. In one embodiment, the Tabsling™ option 580 or Tabsling™ icon 590 are also modified to reflect a number of received and unread or unviewed transmissions (see FIG. 5D for example, which reflects the that four new transmissions have been received.

When a user selects the Tabsling™ option 580 in response to the notification of a newly received transmission, the communication bar 560 can be displayed to reflect the Web content and/or commentary associated with the newly received transmission.

For some embodiments, particularly those that involve the receipt of multiple new transmissions, a user may also be required to specifically select/identify the transmission they wish to view prior to the transmission being displayed in the communication bar 560. For example, a user may be required to select one or more transmissions from a menu 580, as displayed in FIG. 5D, for example, prior to displaying the one or more transmissions in interfaces such as the communication bar 560.

It will be appreciated that any number of communication bar interfaces 560 can also be displayed at the same time, and for any predetermined reason, such as, for example, in response to user input or automatically in response to the receipt of new transmissions and/or in response to the selection of a menu item or displayed object.

The communication bar interface 560 includes various features found in many of the other embodiments described above, including a comments field 562 for displaying comments, which may be displayed with or without a scroll bar, as necessary. An information field 569 is also provided to provide information about the transmission, such as the sender of the transmission and how long ago it was sent and/or received from the sender. In some embodiments, an avatar, picture or other contact persona icon 568 is displayed with the transmission which is associated with the sender. This can be beneficial for providing a quick visual identification of the sender without requiring the recipient to read the text in the information field 569.

The communication bar 560 can also include standard control options, such as the close window option 566. New options can also be provided, such as the view page option 564, which selectably enables the recipient to view the web content or webpage that was transmitted. This embodiment is an alternative embodiment to some of the previous embodiments in which the web content was automatically populated into a tab within a browser window. According to this embodiment, for example, a recipient must selected the view page option 564 prior to the web page actually being displayed by the browser.

The time it takes to display the web content can still be reduced, however, by preloading the web content into a cache at the recipient system, such as by downloading all or a part of the web content from a web server, for example, including any embedded hyperlink data, and such that the web page and any embedded hyperlinks are readily loadable at the instant the recipient selects the view page icon 564.

FIG. 5C illustrates another embodiment of a communication bar interface 570 that can be used to add commentary to a web page that is going to be transmitted to a recipient. This communication bar interface 570 can be displayed by selecting one of the icons displayed by the browser, or by selecting a function key or other option associated with the communication bar interface 570. In one embodiment, a user selects the Tabsling™ option 580 or Tabsling™ icon 590 or another similar icon displayed on the browser to launch the communication bar interface 570 for sending web content that is currently displayed at a sender's system. As shown, the communication bar interface 570 can include control options 579, as well as an address of the web page being transmitted. Commentary is also shown in a commentary window 572. The commentary can be automatically populated into the commentary window 572 when the system parses the web page and identifies commentary that summarizes the content of the web page or that identifies and summarizes a context of the content. In some embodiments, headers or a predetermined portion of the leading text is provided in the commentary window 574. In alternative embodiments, a user can edit or add commentary to the commentary window 574, by clicking on the window 574, for example. Other examples for adding commentary are described throughout this paper, including the examples described in reference to FIGS. 3A-4B.

Once a sender is happy with the content to be transmitted, the sender can select a recipient to send the transmission to by an email address that is entered into a field that is displayed when an email icon 574 is selected. Alternatively, or in combination, a sender can select one or more recipients from an address book menu 578. Finally, the transmission is sent when a sender selects the sling icon 576.

FIG. 5D illustrates one embodiment of an icon 590 that can be selected to display one or more listings of received and sent web content transmissions within a displayed menu 580, as previously discussed.

The displayed menu 580 of received 582 and sent 584 transmissions can be listed as slings, transmissions or any other reference designators. According to one embodiment, the sent and received transmissions are visually distinguished by more than mere terms, however, such as by including line breaks, different colors, different fonts and/or in some other distinguishing presentation.

According to the present embodiment, the displayed menu 580 is displayed in response to a user selecting the Tabsling™ icon 590. According to this embodiment, the Tabsling™ icon 590 is displayed with a number character 592 to reflect a number of new transmissions. The new transmissions are not presently distinguished. However, it will be appreciated that the new transmissions can be visually distinguished by changing their font size, color, type and/or by changing the location of the listed transmissions with respect to old transmissions (such as, for example, by placing the new transmissions at the top of the list).

According to one embodiment the transmissions are also displayed with check boxes that can be checked to identify one or more transmissions to open or forward in response to a single command function.

The transmissions can also be displayed with numeral indicators 587 that indicate a number of comments received for each transmission, as well as with a selectable link 588, for opening the corresponding commentaries.

Finally, it is noted that the menu can be presented with a selectable option 586 for viewing archived transmissions or slings that are no longer displayed on the menu 580. According to some embodiments, transmissions are no longer displayed on the menu 580 after a certain predetermined period of time has passed since they were last sent, received and/or selectably viewed. Older transmissions may also be pushed off of the menu 580 in deference to more recent transmissions.

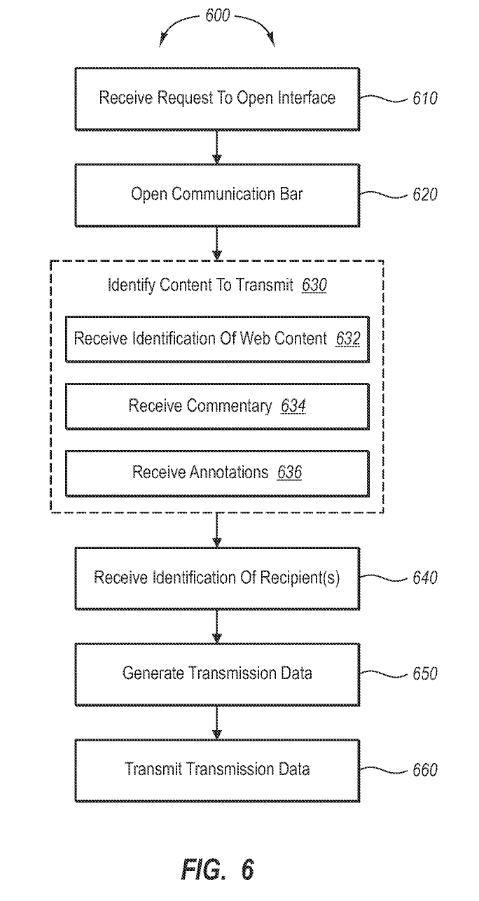

Attention will now be directed to FIGS. 6-8, which illustrate flowcharts for implementing some of the methods of the invention and for utilizing some of the interfaces described above.

In FIG. 6, a flowchart 600 is illustrated that includes a step (630) and various acts (610, 620, 632, 634, 636, 640, 650 and 660) associated with sending a data transmission, such as a Tabsling™, each of which will now be described.

The first illustrated act is the act of receiving a request to open a Tabsling™ interface (610). This can be performed, for example, when a user selects a menu option, such as option 580 in FIG. 5 or 212A in FIG. 2, from a browser or another application, as described above. In response to the request for a Tabsling™ interface (610), the computing system opens a communication bar (620) or another interface that can be used to send Web content without requiring the use of a displayed email interface.

Content to transmit or Sling™ is also identified (step 630). This step is a functional step that includes various corresponding acts. While some of these acts are illustrated, it will be appreciated that other similar acts can also be performed to identify content. The content that is identified can be any type of content, including a single webpage, a plurality of webpages or any selected portion of Web content. This includes the actual content displayed or references (URLs and MRLs) that reference the webpage(s). The content can also include annotated and modified Web content, separate annotations and commentary associated with and transmitted with the Web content.

Some of the acts that can be performed to identify content, according to step 630, include receiving an identification of Web content (act 632) such as when a user selects an option to transmit or Sling™ a particular webpage. This can occur, for example, at the same time a user requests the Tabsling™ interface (610) or another interface, by selecting options displayed on the browser (e.g., option 580, option 212A or other options) and at the same time the webpage(s) or Web content is being displayed. Content can also be identified when a user types in a particular URL or MRL.

A user can also identify content by providing commentary (act 534) in one or more fields of the communication bar, as described in reference to FIGS. 2A-5, and which will be transmitted with Web content or that will be transmitted in a Tabsling™ or another transmission packet that associates the commentary with particular Web content or a previous transmission.

A user can also identify content by providing annotations 636 through a communication bar or another interface, as described, for example, in reference to FIG. 5. In view of the foregoing, it will be appreciated that the content identified (step 630) can include any combination of Web content, commentary and annotations.

The identification of Web content can also occur automatically, according to some embodiments. For example, according to personal settings, a server can be configured to automatically look for and identify content satisfying one or more settings corresponding to a particular subject, person or site. In some instances, changes in a monitored website trigger identification of that website. Identification of content that is transmitted through the server can also satisfy the act of identifying content to transmit to an addressed recipient and/or to a new recipient. A WebCrawler can also be configured to actively search for and identify content to transmit based on personal settings of content to search for.

The computing system also receives identification of the one or more recipients that the identified content should be sent to (640). This can be done when a user registers for the receipt of particular Tabslings™ or other data transmissions. As described above, in reference to FIGS. 2A-5, there are also various menu interfaces that can be used to identify potential recipients. Recipients can also be identified individually and by group. In some instances, identification of a recipient (640) also includes identifying one or more specific devices the Tabsling™ or other transmission should be sent to. This embodiment is particularly useful when a recipient is associated with a plurality of devices or computing systems (e.g., phone, PDA, laptop, desktop, work computer and so forth). When a recipient is associated with a plurality of different devices or aliases, the present invention provides interfaces (not shown) for enabling a sender to select the desired device(s) and alias(es) of the recipient(s). This selection also enables the inventive interfaces and communication modules to identify and utilize the appropriate transmission protocols to ensure the identified content is transmitted in an appropriate format, even when the appropriate format may require some modification.

Once the computing system has received this information through the Tabsling™ interface(s) or another interface, a transmission packet or block of packets is created. The transmission packets include information identifying the Web content, commentary and/or annotations that were previously identified, as well as the recipient(s)/recipient device(s) and, in some instances, the appropriate transmission protocols.

Other included information can comprise restrictions, privacy and prioritization data that is usable by a server or recipient system to restrict access or use to the content or that define priorities for routing and displaying the content. This information can be used to set restrictions that prevent spam from being received, such as, for example, so that transmissions will only be received from a particular individual or group. The included information can also specify that the content should be pushed to a recipient by a server or only cached until a recipient pulls it from the server.

Priority data can also be provided to cause the content to be automatically displayed at the recipient system, or alternatively, to only be displayed when certain criteria are met at the recipient system (such as receiving user input selecting a browser menu option or selecting a background tab within a browser at the recipient system). Any other type of criteria can also be established. It will be appreciated, however, that while these criteria may be established and received through interfaces at the sending computing system, and attached to a transmission packet, for example, similar and sometimes overriding criteria can also be established at the recipient or server computing systems, as described in more detail below.

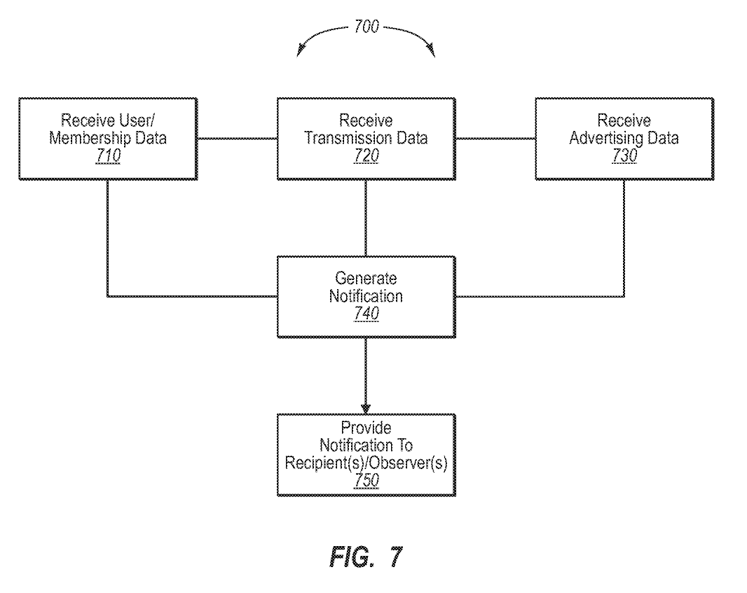

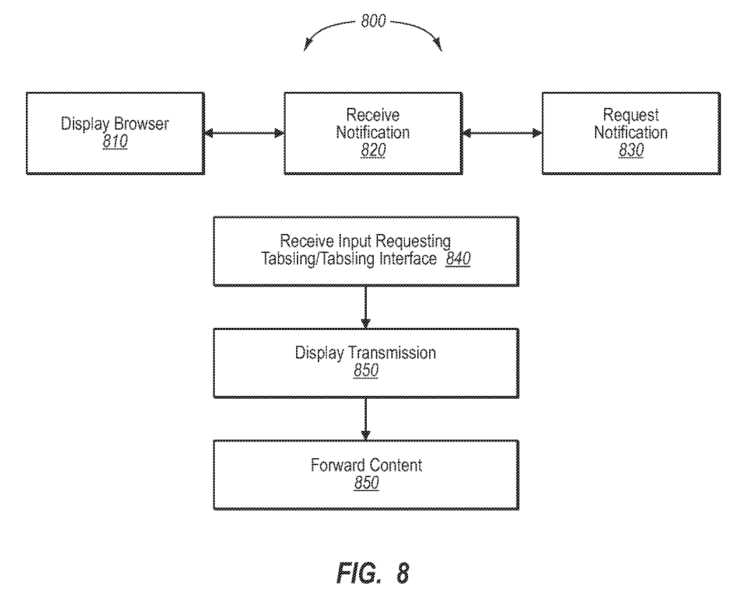

Once the transmission data is generated (650), it is transmitted to the one or more recipient(s) (660). Transmitting the Tabsling™ data or other transmission data (660) to a recipient can include transmitting the data (660) to a server, which subsequently routes the data to one or more identified recipient(s). The server can either push the data to the recipient(s) or, alternatively, only transmit the data to the recipient(s) when the recipient(s) request the data in a pull type system. Additional information regarding the involvement of the server and the recipient is provided below in reference to FIGS. 7 and 8.

In FIG. 7, for example, a flowchart illustrates various acts performed by a server system that is interposed between a sender and a recipient. As illustrated, a server receives tabling transmission data (720) along with membership and user data (710) and advertising data (730). These various types of data can be received in any order and from different sources. In one embodiment, a user provides membership data when the user subscribes for Tabsling™ services, to enable the transmission and/or receipt of Tabslings™ and other similar data transmissions. Membership data also includes information regarding an observer status and information regarding the creation or joining of a group.

When a user subscribes to the Tabsling™ services, one or more modules are received by the user and downloaded onto the user's computing system and which enable many of the embodiments described herein. In other instances, the user accesses the services through one or more remote host systems, such as through a Citrix server system. In yet other instances, user membership merely unlocks functionality already built into future browsers and which enable the methods of the invention.

The transmission data is received from one or more senders (720), as described above with reference to FIG. 6. Advertising data can also be received from one or more third party sources. To enable many of the targeted advertising embodiments and the placement of contextually relevant advertising, the advertisers can also provide criteria to apply and keywords to look for within a particular transmission or in a user's profile, along with associated advertisements. While the advertisements can be added to a transmission, such as a Tabsling™, by an intermediary server system, the advertisements can also be added by a recipient system and/or a sender system.

Irrespective of whether an advertisement is selected or appended, the server will generate a notification 740 for a recipient corresponding to information received from the sender, the recipient and/or an advertiser. The notification is then provided to the one or more recipient(s) (750). It will be appreciated that the recipient(s) in this context can include observers.

The notification provided to the recipient(s) can include anything from an instant message notice, an email notice, or another notice that is visible to the user or transparent to the user and that informs the user's browser, the user's computing system or the user of the presence of a transmission, such as a Tabsling™, that is available for downloading from a Tabsling™ server or other computer, for example.

In some embodiments, the notice can also include the actual content being transmitted, including Web content, annotations, and/or commentaries associated with the content, including any advertisements. In other embodiments, the notification comprises instructions for controlling how the content will be loaded, an order for loading, privacy restrictions that restrict viewing to a particular user and/or only after a password is provided and so forth. The notification can also comprise a modification of the original content, commentary and other transmission data sent from the sender, so as to comply with particular protocols or preferences.

Regardless of the type of notice, and how the recipient(s) receive and respond to the notice, the notice comprises a means for notifying the recipient(s) of the transmission and in some instances, for providing the actual content.

Although the foregoing discussion has not described the specific protocol to use in transmitting and routing transmissions, such as Tabslings™, it will be appreciated that virtually any protocol can be used, irrespective of whether the transmission includes the actual content to be displayed or merely a reference or link to the content, including wireless and wired protocols.

FIG. 8 illustrates many of the acts involved at the recipient system(s) for receiving and displaying transmissions, such as Tabslings™. As shown, the recipient system(s) display a browser, such as a Tabsling™ enabled browser (810). This may include an existing browser that is enhanced with a downloaded patch or script having computing instructions for enabling the present invention or, alternatively, a future browser that is specifically designed and built with the functionality described herein for enabling the display of data transmissions, including, but not limited to Tabslings™.

The browser can be displayed (810) automatically in response to receiving a notification of a Web content data transmission (820), for example, or in response to any other input received from a user or a computing system that causes the browser to be loaded and displayed.

Before or after the browser is loaded, the recipient system can request that a notification be received (830). This request can include a previous request that all notifications addressed to the recipient be pushed to the recipient automatically, such as, for example, at a particular computing device. The request can also involve the loading of a browser, wherein part of the process for loading the browser causes the browser to query for and request or pull data from the server or another computer whenever the browser is loaded or a button is selected from the browser. This may require the recipient to first login to a host server. While a recipient may need to manually login to a server, according to some embodiments, in order to receive their data transmissions, it will be appreciated that the identification and authentication of a recipient can also be performed automatically. It will also be appreciated that the request for Tabslings™ or other data transmissions can also merely require the selection of a menu option (such as option 580 in FIG. 5) from the browser or another application at any time after the browser is running.

The displayed act of requesting notifications (830) can also include corresponding acts of selecting and setting personal preferences for controlling how data is received and the types of data that is received. For example, these controls can establish whether data is pushed to the recipient or whether it is to be pulled from the server by the recipient.

The controls and preferences set for receiving notifications can also include priorities for setting the number of Tabslings™ or other transmissions to initiate loading for at one time or the total number of Tabslings™, transmissions, commentaries, or tabs that can be loaded and displayed to a recipient at one time. This is particularly useful when a single Tabsling™ includes MRLs or a plurality of webpages.

Settings can also be selected to cause Tabslings™ or other transmissions to be displayed automatically in the forefront of a browser display, and without requiring any additional user input, such as high priority Tabslings™ or Tabslings™ received from a particular sender or that are addressed to a particular group or that involve a particular subject matter.

In other instances, the settings can cause Tabslings™ or other transmissions to be loaded only in a background and such that they are only accessible when a user selects a tab on the browser chrome. If multiple notifications or transmissions are received at once, the settings can also control the prioritization order in which the transmitted contents loaded, such as, for example, based on the type of content, the identification of the sender, the addressed recipients, priority information or any other information.

Irrespective of the timing in which the notification is received (which, as mentioned above, can include Web content), the recipient system receives a request for an interface, such as a Tabsling™ interface (840). The requested interface can be an enhanced browser, the communication bar described above, or any other interface.

According to one embodiment, the requested interface is any interface other than a traditional email interface and that is opened to view Web content. According to another specific embodiment, the requested interface is any interface that frames or that is displayed with Web content that is automatically loaded without requiring a user to initiate the loading of the content by clicking on a hyperlink or to entering in a specific URL.

In some instances the requested interface frames the Web content in a window loaded in a background of the Internet, such that it is only accessible by clicking on a tab in the Internet browser. The tab that is clicked on can also be a tab that is distinguished from other existing tabs, by location, color and/or size. In some embodiments, the interface must also include functionality and space for displaying commentaries regarding the Web content. Some examples of the interfaces are found in FIGS. 2A, 3A and 5. Portions of the interfaces are shown in FIGS. 2B, 3B and 4A-4B.

The request for the interface (840) can be received at the same time a browser is loaded (810) or in response to a user selection of an interface option (such as option 580 of FIG. 5). The request for the interface (840) can also be received automatically and as part of the request to receive a notification (830) or in response to and as part of a receiving a notification (820) that is pushed to the recipient. For example, in one embodiment, the interface is automatically loaded, in response to receiving transmitted data, within one or more tabbed windows loaded in the background of the browser, each of which remains in the background until they are selected by the recipient.

When the interface is loaded, the one or more received transmissions are displayed within the interface (850). The act of displaying the transmissions (850) can include scanning a notification for Web content embedded in the notification or that is referenced by the notification, as well as automatically accessing and loading the identified Web content within one or more browser tabs/windows.

Displaying the transmissions (850) also includes displaying commentary associated with the transmissions, such as in the communication bar illustrated in FIGS. 2A-5. The act of displaying the transmissions (850) can also include displaying the annotations, if any, that are included or referenced within the notification.

The act of displaying a transmission (850) can also include analyzing and filtering content in the transmission and omitting certain undesired content or content received from particular sources. The act of prioritizing the manner in which Tabslings™ or other transmissions are loaded or displayed is also included within the act of displaying the transmissions (850).

Displaying the transmissions (850) can also include identifying and/or selecting advertisements that are contextually relevant or targeted to a particular recipient or group and displaying the advertisements.

Displaying the transmissions (850) can also include requiring a recipient to enter a PIN or other verification information, requested by the Tabsling™ interface or another interface, prior to displaying the content. This embodiment can be useful, for example, when a sender wants to prevent the transmitted content from being displayed arbitrarily to any person who might have access to a recipient system. While login information and authentication information can be received prior to sending any Tabslings™ or other transmissions to a recipient, specific authorizations can also be required to access any particular transmission that is already sent to and loaded into the recipient computer.

After the transmission is displayed (850), the illustrated method includes forwarding content (860), which can essentially include any of the acts recited above with regard to sending a Tabsling™ or other transmission described in reference to FIG. 6, including adding commentary, annotating, and selecting content to send, as well as identifying the one or more recipients.

There are also many other permeations and alternative embodiments that fall within the scope of the present invention. Accordingly, while specific embodiments have been illustrated and described, these embodiments are to be considered in all respects only as illustrative and not restrictive. Furthermore, while the foregoing subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

In as much as the present invention may be embodied in many other specific forms without departing from its spirit or essential characteristics, the scope of the invention is, therefore, indicated by the appended claims rather than by the foregoing description. All changes which come within the meaning and range of equivalency of the claims are to be embraced within their scope.

What is claimed is:

1. An interface which is displayable with an Internet browser and which comprises:
an interface element for identifying Web content to be transmitted to a recipient in a corresponding transmission, wherein the identified Web content is displayed by a first Internet browser that is hosted by a sending computing system;
an interface element for identifying a recipient of the transmission and the corresponding Web content;
computer-executable instructions for generating the transmission comprising transmission data that identifies the Web content and the recipient;
computer-executable instructions for transmitting the transmission and corresponding transmission data to a recipient computing system, wherein receipt of the transmission at the recipient computing system causes the recipient computing system to automatically load the Web content identified in the transmission data into a browser tab of a second Internet browser that is hosted by the recipient computing system.

2. An interface as recited in claim 1, wherein the browser tab is a background browser tab and such that the Web content is only visible to the recipient at the recipient computing system after the browser tab is selected and displayed in a forefront of the browser hosted by the recipient computing system.

3. An interface as recited in claim 1, wherein the interface further includes a Tabsling™ button that is displayed on the chrome of the browser hosted by at least one of the sending and recipient computing system.

4. An interface as recited in claim 3, wherein a user selection of the Tabsling™ button at a particular time in which particular Web content is displayed by the first Internet browser causes the interface to identify that particular displayed Web content as the Web content to be transmitted.

5. An interface as recited in claim 3, wherein a user selection of the Tabsling™ button causes the interface to display a corresponding communication bar.

6. An interface as recited in claim 5, wherein the particular Web content is framed by browser chrome of the first Internet browser and wherein a user selection of the Tabsling™ button causes the interface to display the corresponding communication bar in a bottom portion of the browser chrome that is displayed below the particular Web content by the browser.

7. An interface as recited in claim 5, wherein the communication bar provides options for selecting one or more recipients of the identified Web content.

8. An interface as recited in claim 5, wherein the interface further includes computer-executable instructions for receiving commentary at the communication bar from a sender and for including the commentary in the transmission data.

9. An interface as recited in claim 1, wherein the interface further includes computer-executable instructions for annotating the identified Web content in such a way that the annotations will be displayed by the recipient computing system when the loaded Web content is subsequently displayed in response to user input selecting a display of the loaded Web content.

10. An interface as recited in claim 1, wherein the first and second Internet browsers are different instances of a same browser application type.

11. An interface which is displayable with an Internet browser and which comprises:
computer-executable instructions for a recipient computing system receiving a notification, wherein the notification includes information identifying Web content to be displayed at the recipient computing system and that was originally identified and selected at a sending computing system and sent to the recipient computing system; and
computer-executable instructions for automatically loading the Web content into a tabbed window of a browser at the recipient computing system upon receiving the notification.

12. An interface as recited in claim 11, wherein the tabbed window is only loaded into a background of the browser in such a manner that loaded Web content is not visible until the tabbed window is selected from the background to be displayed in a foreground of the browser.

13. An interface as recited in claim 12, wherein the tabbed window is identified by a tab object that is displayed vertically below at least one other tab object corresponding to another tabbed window of the browser.

14. An interface as recited in claim 11, wherein the notification is only received by the recipient computing system after, and in response to, the recipient computing system first launching an instance of the browser at the recipient computing system and a recipient logging into a service that is storing the notification.

15. An interface as recited in claim 11, wherein the interface further includes computer-executable instructions for filtering content identified within a notification to prevent at least some of the filtered content from being displayed at the recipient computing system and in response to user settings established by a recipient.

16. An interface as recited in claim 11, wherein the interface includes a button that, when selected, causes the interface to display a corresponding communication bar that is configured for receiving commentary from a recipient of the notification and for forwarding the commentary to one or more selected recipients identified through the communication bar.

17. An interface as recited in claim 11, wherein the interface further includes computer-executable instructions for setting and applying priorities for loading content received in a transmission from one sender prior to loading content received in another transmission from another sender.

18. An interface as recited in claim 11, wherein the notification includes identification of a plurality of webpages in a MRL and wherein the computer-executable instructions for automatically loading the Web content into a tabbed window of a browser includes computer-executable instructions for automatically loading the plurality of webpages into separate tabbed windows of the browser at the recipient computing system.

19. A computer-readable storage media comprising:
stored computer-executable instructions for presenting an interface which is displayable with an Internet browser, wherein the interface comprises:
a selectable button that is displayed by a browser hosted by a computing system, and which, when selected, causes a communication bar to be displayed within the browser and which includes tools for identifying one or more recipients of a transmission, comprising identified Web content, and for receiving commentary and annotations regarding the Web content that is identified in the transmission;
computer-executable instructions for automatically loading received Web content identified in a received transmission within a tabbed window of the browser at the computing system within a new chrome layer of the browser that is vertically offset and distinguished from a preexisting chrome layer that identifies one or more other tabbed windows of the browser.

20. A computer-readable storage media as recited in claim 18, wherein the new chrome layer is only created for the browser at a time after the preexisting chrome layer was created, and upon receiving the Web content identified in the transmission.
